(19) United States
(12) Patent Application Publication
(10) Pub. No.: US 2017/0017248 A1
(43) Pub. Date: Jan. 19, 2017

(54) SYSTEMS AND METHODS FOR PREPARING FOOD ITEMS

(71) Applicant: General Electric Company, Schenectady, NY (US)

(72) Inventors: James Lee Armstrong, Louisville, KY (US); Stephen Bernard Froelicher, Shepherdsville, KY (US); Kevin Farrelly Nolan, Louisville, KY (US); Christopher James Adelmann, Louisville, KY (US)

(21) Appl. No.: 14/799,943

(22) Filed: Jul. 15, 2015

(51) Int. Cl. G05D 23/19; G05B 15/02

(52) U.S. Cl. CPC G05D 23/1917; G05B 15/02

(57) ABSTRACT

Systems and methods for preparing food items are provided. A method includes obtaining a cooking profile for the food item from a plurality of cooking profiles stored on a remote server. Each of the plurality of cooking profiles includes a food item style and a plurality of cooking factors associated with the food item style. The method further includes configuring an oven appliance for cooking based on each of the plurality of cooking factors of the obtained cooking profile.

### FIELD OF THE INVENTION

The present subject matter relates generally to systems and methods for preparing food items, such as pizzas, and more specifically to systems and methods which utilize previously determined cooking profiles for preparing such food items.

### BACKGROUND OF THE INVENTION

Restaurants often have very expensive, specialized appliances for cooking certain types of food items. For example, many restaurants have custom-made, wood-fired brick ovens that are used for cooking pizza, bread and other food items that are desired to be cooked at high temperatures. These ovens typically include a hearth and a dome made from refractory materials and a cooking deck covered by the dome. Food to be cooked is typically placed directly onto the cooking deck and is heated via three different types of heat transfer. Specifically, due to the dome, the oven has a natural airflow therethrough that provides for convective heating. In addition, the dome's surface reflects heat downward towards the cooking deck to provide radiative heating onto the food placed on the deck while heat is transferred directly to the food from the cooking deck via conduction.

Many consumers desire to mimic restaurant-quality food items, such as pizzas, at home using conventional oven appliances. In many cases, however, the consumer is unaware of the many different and factors that are utilized, and varied, from food item to food item, such as from pizza style to pizza style. For example, different temperatures and times, as well as differences in other factors, may be utilized to prepare a Neapolitan pizza versus a New York- or Chicago-style pizza. The consumer may thus be disappointed in the quality of the home-prepared food item relative to comparative restaurant-prepared food items.

Accordingly, improved methods and apparatus for preparing food items, such as pizzas, are desired in the art. In particular, methods and apparatus which utilize previously determined cooking profiles to mimic restaurant-style cooking conditions for specified food item styles would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment, a method for preparing a food item is provided. The method includes obtaining a cooking profile for the food item from a plurality of cooking profiles stored on a remote server. Each of the plurality of cooking profiles includes a food item style and a plurality of cooking factors associated with the food item style. The method further includes configuring an oven appliance for cooking based on each of the plurality of cooking factors of the obtained cooking profile.

In accordance with another embodiment, a system for preparing a food item is provided. The system includes a remote server, the remote server storing a plurality of cooking profiles, each of the plurality of cooking profiles comprising a food item style and a plurality of cooking factors associated with the food item style. The system further includes an oven appliance. The oven appliance includes a cabinet defining a cooking chamber. The cooking chamber is configured for receipt of food items to be cooked and includes a top wall and a bottom wall spaced from the top wall along a vertical direction. The oven appliance further includes a lower heating assembly, the lower heating assembly including a heating element disposed within the cooking chamber adjacent the bottom wall. The oven appliance further includes an upper heating assembly, the upper heating assembly including a heating element disposed within the cooking chamber adjacent the top wall. The oven appliance further includes a temperature sensor disposed within the cooking chamber, and a controller in communication with the remote server and operable to obtain a cooking profile of the plurality of cooking profiles. The controller is further operable to configure the oven appliance for cooking based on each of the plurality of cooking factors of the obtained cooking profile.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an oven appliance in accordance with one embodiment of the present disclosure;

FIG. 2 provides a sectional view of the oven appliance of FIG. 1 taken along the line 2-2 of FIG. 1;

FIG. 3 provides a sectional view of an oven appliance in accordance with another embodiment of the present disclosure;

FIG. 4 is a schematic diagram of a system for preparing food items in accordance with one embodiment of the present disclosure; and

FIG. 5 is a flow chart of a method for preparing food items in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

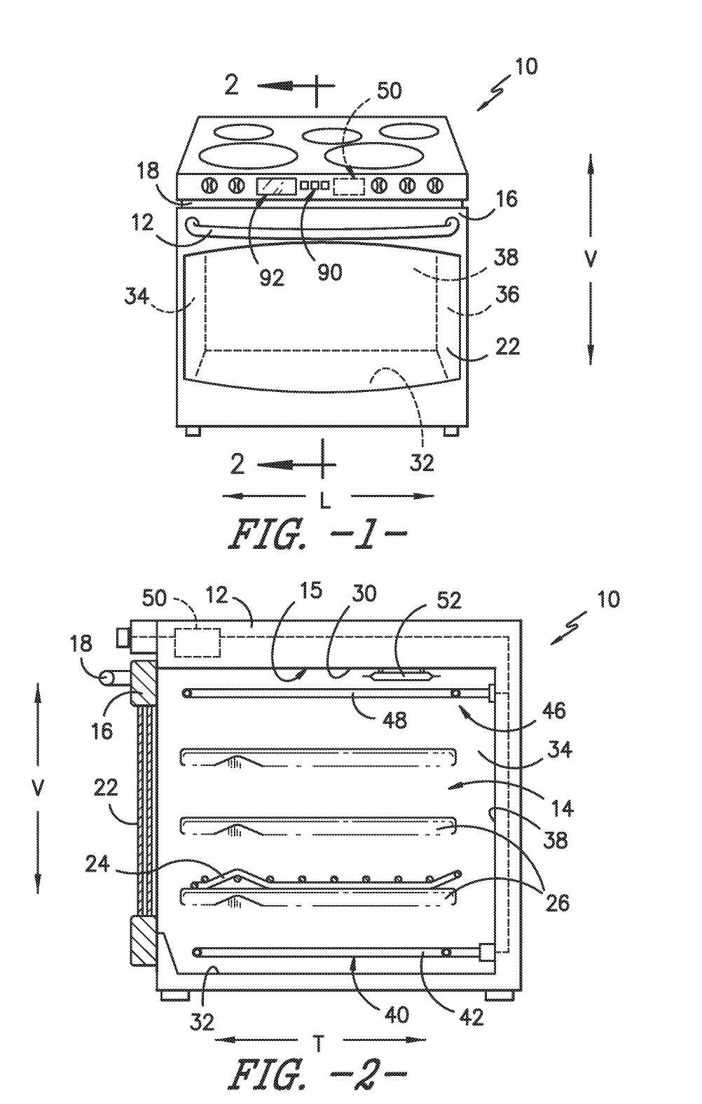

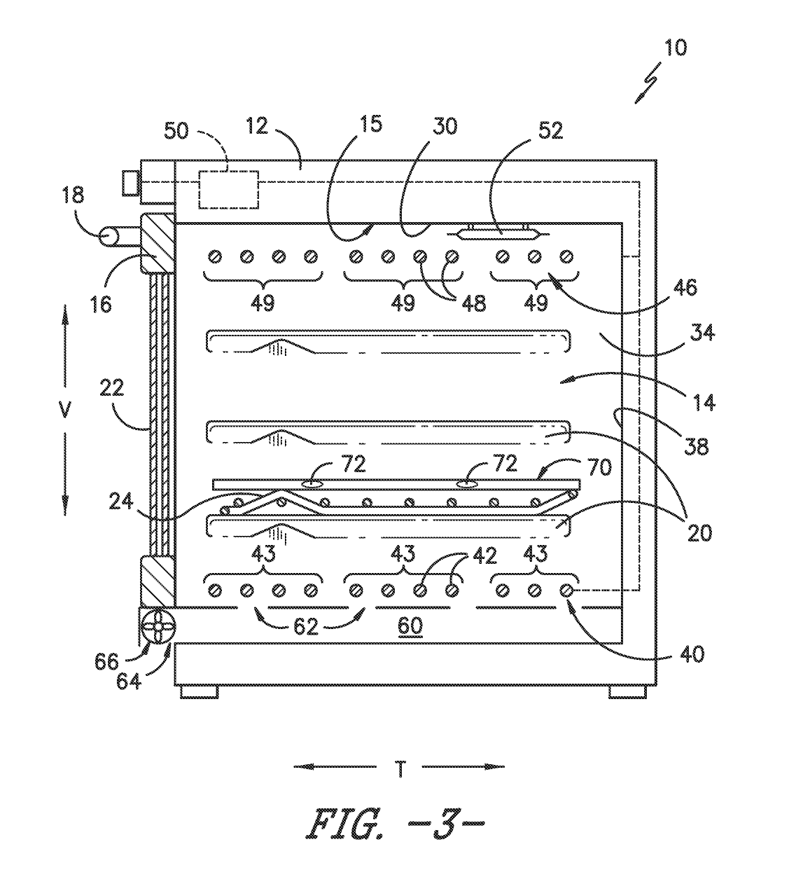

FIG. 1 provides a perspective view of an oven appliance 10 according to an exemplary embodiment of the present subject matter. FIG. 2 provides a section view of oven appliance 10 taken along the 2-2 line of FIG. 1. Oven appliance 10 defines a vertical direction V, a lateral direction L and a transverse direction T. The vertical, lateral and transverse directions are mutually perpendicular and form an orthogonal direction system. As will be understood by those skilled in the art, oven appliance 10 is provided by way of example only, and the present subject matter may be used in any suitable oven appliance. Thus, the present subject matter may be used with other oven or range appliance configurations, e.g., that define multiple interior cavities for the receipt of food and/or having different pan or rack arrangements than what is shown in FIG. 2.

Oven appliance 10 includes an insulated cabinet 12 with an interior cooking chamber 14 defined by an interior surface 15 of cabinet 12. Cooking chamber 14 is configured for the receipt of one or more food items to be cooked. Oven appliance 10 includes a door 16 rotatably mounted to cabinet 12, e.g., with a hinge (not shown). A handle 18 is mounted to door 16 and assists a user with opening and closing door 16 in order to access cooking chamber 14. For example, a user can pull on handle 18 to open or close door 16 and access cooking chamber 14.

Oven appliance 10 can includes a seal (not shown) between door 16 and cabinet 12 that assist with maintaining heat and cooking fumes within cooking chamber 14 when door 16 is closed as shown in FIG. 2. Multiple parallel glass panes 22 provide for viewing the contents of cooking chamber 14 when door 16 is closed and assist with insulating cooking chamber 14. A baking rack 24 is positioned in cooking chamber 14 for the receipt of food items or utensils containing food items. Baking rack 24 is slidably received onto embossed ribs 26 or sliding rails such that rack 24 may be conveniently moved into and out of cooking chamber 14 when door 16 is open.

As shown, various sidewalls define the cooking chamber 14. For example, cooking chamber 14 includes a top wall 30 and a bottom wall 32 which are spaced apart along the vertical direction V. Left sidewall 34 and right sidewall 36 (as defined according to a front view as shown in FIG. 2) extend between the top wall 30 and bottom wall 32, and are spaced apart along the lateral direction L. A rear wall 38 may additionally extend between the top wall 30 and bottom wall 32 as well as between the left sidewall 34 and right sidewall 36, and is spaced apart from the door 16 along the transverse direction T. Cooking chamber 14 is thus defined between the top wall 30, bottom wall 32, left sidewall 34, right sidewall 36, and rear wall 38.

A lower heating assembly 40 may be included in oven appliance 10, and may include one or more heating elements 42, e.g. bake heating elements. Heating elements 42 may be disposed within the cooking chamber 14, such as adjacent bottom wall 32. In exemplary embodiments as illustrated, the lower heating elements 42 are electric heating elements, as is generally understood. Alternatively, the lower heating elements 42 may be gas burners or other suitable heating elements having other suitable heating sources. Heating elements 42 may generally be used to heat cooking chamber 14 for both cooking and cleaning of range appliance 10.

Additionally, an upper heating assembly 46 may be included in oven appliance 10, and may include one or more upper heating elements 48, e.g. broil heating elements. Heating elements 48 may be disposed within the cooking chamber 14, such as adjacent top wall 30. In exemplary embodiments as illustrated, the upper heating elements 48 are electric heating elements, as is generally understood. Alternatively, the upper heating elements 48 may be gas burners or other suitable heating elements having other suitable heating sources. Heating elements 48 may additionally generally be used to heat cooking chamber 14 for both cooking and cleaning of range appliance 10.

The operation of oven appliance 10 including heating elements 42 and 48 (and heating assemblies 40, 46 generally) may be controlled by a processing device such as a controller 50. Controller 50 may be in communication (via for example a suitable wired or wireless connection) with the heating elements 46, 48 and other suitable components of the oven appliance 10, as discussed herein. In generally, controller 50 may be operable to configure the oven appliance 10 (and various components thereof) for cooking Such configuration may be based on a plurality of cooking factors of a selected cooking profile, as discussed herein. By way of example, the controller may include a memory and one or more processing devices such as microprocessors, CPUs or the like, such as general or special purpose microprocessors operable to execute programming instructions or micro-control code associated with operation of appliance 10. The memory may represent random access memory such as DRAM, or read only memory such as ROM or FLASH. In one embodiment, the processor executes programming instructions stored in memory.

The memory may be a separate component from the processor or may be included onboard within the processor.

Such controller 50 may also be communication with a temperature sensor 52 that is used to measure temperature inside cooking chamber 14 and provide such measurements to the controller 50. Temperature sensor 52 is shown (in FIG. 2) in the top and rear of cooking chamber 14. However, other locations may be used and, if desired, multiple temperature sensors may be applied as well.

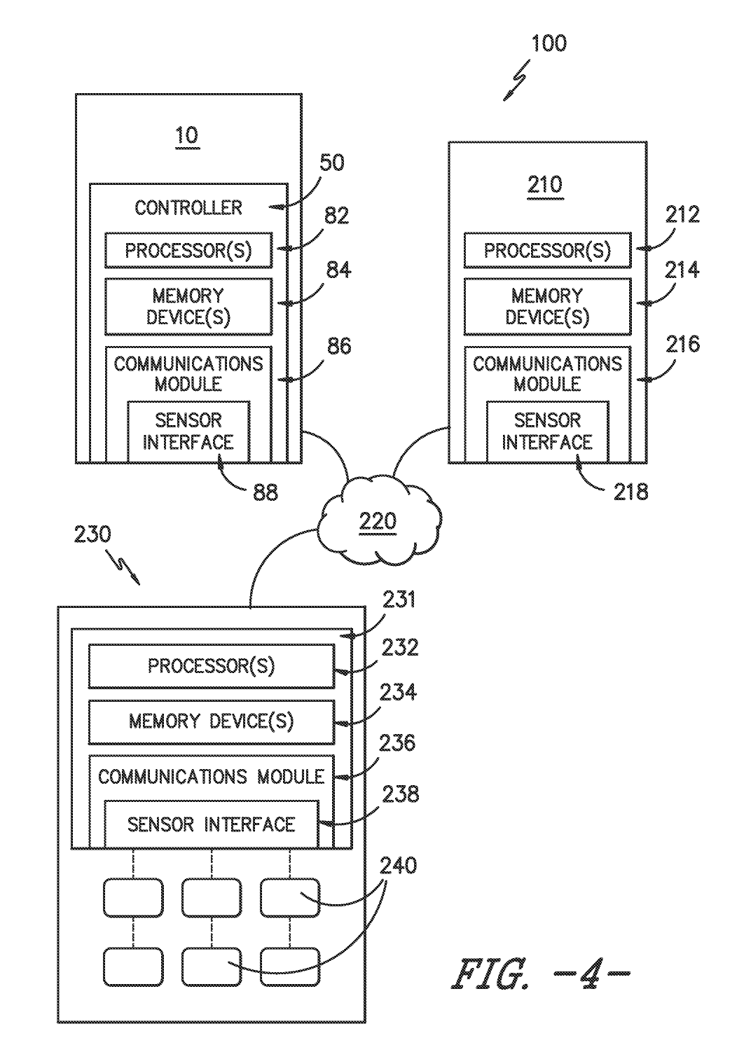

Referring now to FIG. 3, another embodiment of an oven appliance 10 in accordance with the present disclosure is illustrated. As illustrated, a plurality of upper heating elements 42 and a plurality of lower heating elements 48 are provided in cooking chamber 14. The lower heating elements 42 may be arranged in a transversely extending row (extending along the transverse direction T), and the upper heating elements 48 may be arranged in a transversely extending row (extending along the transverse direction T). Further, individual lower heating elements 42 may be grouped together in zones 43 of lower heating elements 42, and individual upper heating elements 48 may be grouped together in zones 49 of upper heating elements 48. Each zone may be individually activated, such as by controller 50, as discussed herein.

Oven appliance 10 may additionally include a channel 60 that is defined external to cooking chamber 14 within cabinet 12. Channel 60 may be disposed below the lower heating assembly 40 along the vertical direction V. Additionally, one or more apertures 62 may provide fluid communication between the channel 60 and cooking chamber 14. An inlet 64 to channel 60 may be open to ambient air external to cooking chamber 14. Further, in exemplary embodiments, a fan 66 may be provided, such as in channel 60 or adjacent to channel 60. The fan may be operable to direct air, such as ambient air external to the cooking chamber 14, into the channel 60. Such air may flow into channel 60 through inlet 64, through channel 60, and from channel 60 through apertures 62 into cooking chamber 14. The air flow in cooking chamber 14 may, for example, cool the underside of a cooking surface within the cooking chamber 14 as desired.

FIG. 3 additionally illustrates one embodiment of a cooking surface on which a food item can be placed within cooking chamber 14 for cooking, in this case a baking stone 70. Baking stone 70 may, for example, be formed from a ceramic or other suitable material. As is generally understood, baking stones 70 are utilized to relatively evenly distribute heat therethrough and thus provide such relatively even distribution of heat to the food item(s) placed on the baking stones 70 during cooking operations. In some embodiments, as illustrated, one or more temperature sensors 72 may be embedded in the baking stone 70. Such temperature sensors 72 may, for example, be in communication with the controller 50 to provide internal baking stone temperature measurements to the controller 50.

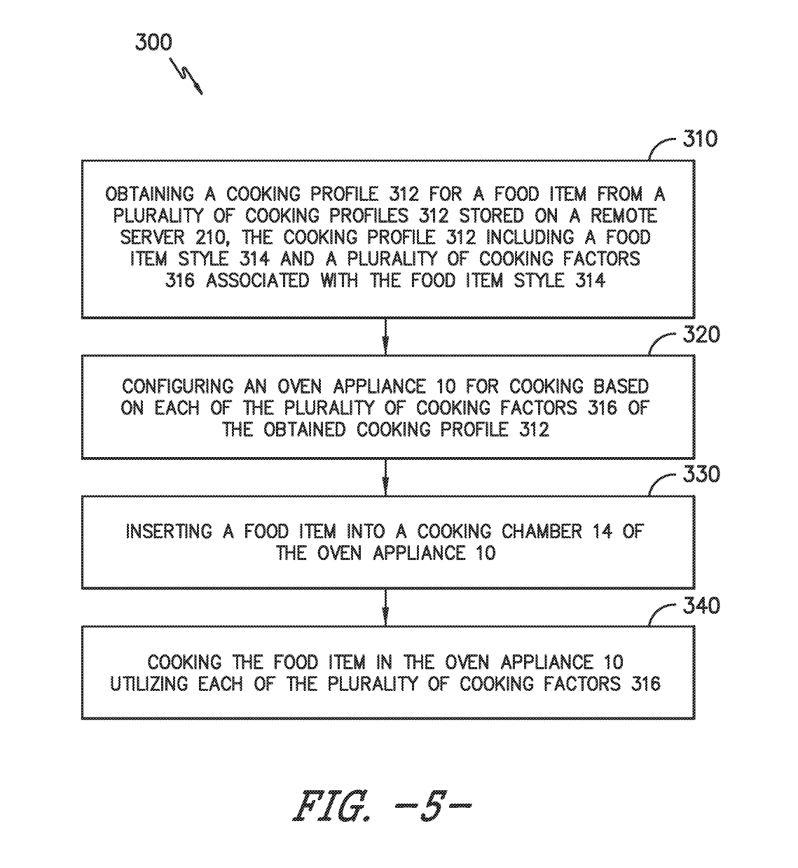

Referring now to FIG. 4, the present disclosure is further directed to systems 100 for preparing food items, such as pizzas. A system 100 may include an oven appliance 10, as discussed above. Oven appliance 10 may include a controller 50. Various components of an exemplary controller 50 are illustrated in schematic fashion. As shown, controller 50 may include one or more processor(s) 82 and associated memory device(s) 84 configured to perform a variety of computer-implemented functions (e.g., performing the methods, steps, and the like disclosed herein). Additionally, the controller 50 may also include a communications module 86 to facilitate communications between the controller 50 and various other components of the system 100, such as a remote server and user interface device, as discussed herein. For instance, the communications module 86 may serve as an interface to permit the controller 50 to transmit and/or receive signals associated with cooking factors and cooking profiles, as discussed herein. Moreover, the communications module 86 may include an interface 88 (e.g., one or more analog-to-digital converters) to permit input signals to be converted into signals that can be understood and processed by the processor 82.

System 100 may further include a remote server 210. The remote server 210 may generally operate to store, receive and transmit signals associated with cooking factors and cooking profiles, and may thus be in communication with the oven appliance 10 and controller 50 thereof. For example, remote server 210 may include one or more processor(s) 212 and associated memory device(s) 214 configured to perform a variety of computer-implemented functions (e.g., performing the methods, steps, and the like disclosed herein). Additionally, the remote server 210 may also include a communications module 216 to facilitate communications between the remote server 210 and controller 50 and various other components of the system 100, such as a user interface device, as discussed herein. For instance, the communications module 216 may serve as an interface to permit the remote server 210 to transmit and/or receive signals associated with cooking factors and cooking profiles. Moreover, the communications module 216 may include an interface 218 (e.g., one or more analog-to-digital converters) to permit input signals to be converted into signals that can be understood and processed by the processor 212.

Server 210 is remote, and thus external to the oven appliance 10, as well as other components of the system 100 such as a user interface device, discussed herein. The server 210 may, for example, be in another room of a house or building in which the system 200 is utilized, or in a neighboring building, etc. Alternatively, and in exemplary embodiments, the remote server 210 is a cloud-based server 210, and is thus located at a distant location, such as in a separate state, country, etc. The remote server 210 may be in wireless communication with the oven appliance 10 (and controller 50 thereof), such as through a network 220. The network 220 may be any type of wireless communications network, such as a local area network (e.g. intranet), wide area network (e.g. Internet), or some combination thereof. The network 220 can also include a direct connection between the client devices, such as oven appliance 10, and a user interface device as discussed herein, and the server 210. In general, communication between the server 210 and the client devices may be carried via a network interface using any type of wireless connection, using a variety of communication protocols (e.g. TCP/IP, HTTP, SMTP, FTP), encodings or formats (e.g. HTML, XML), and/or protection schemes (e.g. VPN, secure HTTP, SSL). Accordingly, wash control information may be transmitted from the controller 50 through the remote server 210 to the user interface using the network 220.

System 100 may additionally include a user interface device 230. The user interface device 230 may be in communication (such as wireless communication) with the remote server 210, such as through the network 220 as discussed herein, and may further be in communication (such as wireless communication)with the oven appliance 50. The user interface device 230 may provide the user with access to cooking factors and cooking profiles, and may be operable, such as by the user, to select a desired cooking profile. The user interface device 230 in exemplary embodiments is independent from the oven appliance 50, and may in some embodiments be, for example, a computer (such as a desktop computer or a laptop), a tablet, a personal telephone (such as a suitable smartphone), or an independent device which functions solely to operate and communicate with the various other components of the system 100.

User interface device 230 may, include a controller 231. The controller 231 may include one or more processor(s) 232 and associated memory device(s) 234 configured to perform a variety of computer-implemented functions (e.g., performing the methods, steps, and the like disclosed herein). Additionally, the controller 231 may also include a communications module 236 to facilitate communications between the device 230 and the server 210. For instance, the communications module 236 may serve as an interface to permit the controller 231 to transmit and/or receive signals associated with cooking factors and cooking profiles. Moreover, the communications module 236 may include an interface 238 (e.g., one or more analog-to-digital converters) to permit input signals to be converted into signals that can be understood and processed by the processor 232. The interface 238 may include or be in communication with input selectors 240 of the device 230, through which a user may provide various inputs are desired.

Referring now to FIGS. 2 through 5, the present disclosure is further directed to methods 300 for preparing food items, such as pizzas. Various of the steps of methods as disclosed herein may, for example, be performed by controller 50, while other steps may, for example, be performed by a user of system 100 and/or an oven appliance 10.

Method 300 may include, for example, the step 310 of obtaining a cooking profile 312 for a food item from a plurality of cooking profiles 312 that are stored on the remote server 210. Such selected profile 312 may be obtained directly by the controller 50 through a request from the controller 50 (based on, for example, a user input to controller 50 via input selectors 90 of oven appliance 10 which are in communication with controller 50) or may obtained indirectly by the controller 50 through a request from the user interface device 230 (based on, for example, a user input to controller 231 via input selectors 240).

Each cooking profile 312 may include a food item style 314 and a plurality of cooking factors 316 associated with the food item style 314. A food item style 314 may, for example, be a desired style of preparation for the food item. For example, when the food item is pizza, exemplary food styles may include Neapolitan, New York-style, Chicago-style, Sicilian, Deep Dish, St. Louis-style, Californian, etc. A plurality of cooking factors 316 may be associated with each food item style 314. Each of these cooking factors 316 may be a variable that contributes to cooking of the food item in the desired food item style 314. An oven appliance 10 can be configured to utilize these cooking factors 316 in order to cook a food item in the desired style 314.

Notably, the cooking factors 316 for each food item style 314 may in exemplary embodiments be empirically determined and stored in remote server 210. For example, in some embodiments, characteristic of restaurant-style food item cooking for each food item style 314 may be collected and analyzed. In some embodiments such as wherein the food item is pizza, a “digital pizza” style measurement device may be utilized collect characteristics of restaurant-style food item cooking, such as of the restaurant-style ovens when cooking pizzas in the various food item styles 314. Exemplary measurement devices and associated systems and methods for determining oven heating parameters are provided in U.S. patent application Ser. No. 14/709,590, filed on May 12, 2015 and which is incorporated by reference herein for all purposes. Oven appliances 10 may be utilized to empirically determine the necessary cooking factors 316 required to reproduce these characteristics. These cooking factors 316 for each food item style 314 may be associated with that food item style 314, and may be stored in remote server 210.

One cooking factor 316 may, for example, be a cooking temperature within the cooking chamber 14, such as measured by temperature sensor 52. Another cooking factor 316 may be a cooking time, such as a cooking time at a specified cooking temperature. The cooking time may, for example, be measured by a timer integrated into controller 50. Notably, a cooking time may include an overall cooking time and/or various cooking time segments at specified cooking temperatures.

Another cooking factor 316 may, for example, be an activation schedule for the lower heating assembly 40 (and elements 42 thereof) and/or an activation schedule for the upper heating assembly 46 (and elements 48 thereof). An activation schedule may be utilized for the upper and lower heating assemblies 40, 46 generally or may be utilized for each individual zone 43, 49 of heating elements 42, 48. The activation schedule for the upper heating assembly 46 may be different from the activation schedule for the lower heating assembly 40, and the activation schedules may differ from zone to zone within the lower heating assembly 40 and/or upper heating assembly 46. An activation schedule may include, for example, one or more activation times and one or more deactivation times. An activation time is a time period during which one or more heating elements, such as of an assembly 40, 46 or zone 43, 49 thereof, are activated and thus producing heat. A deactivation time is a time period during which one or more heating elements, such as of an assembly 40, 46 or zone 43, 49 thereof, are deactivated and thus not producing heat. Accordingly, various heating elements 42, 48 may be alternatively activated and deactivated for various times during cooking in accordance with an activation schedule. An activation schedule may in some embodiments further include one or more power levels during one or more of the activation times. For example, in some embodiments, various heating elements 42, 48 may be activated at full power during an activation time. In other embodiments, various heating elements 42, 48 may be activated at specified power levels less than full power during an activation time.

Another cooking factor 316 may, for example, be an activation schedule for the fan 66. The activation schedule may include, for example, one or more activation times and one or more deactivation times. An activation time is a time period during which the fan 66 is activated and thus directing air through the channel 60. A deactivation time is a time period during which the fan 66 is deactivated and thus not directing air through the channel 60. Accordingly, the fan 66 may be alternatively activated and deactivated for various times during cooking in accordance with an activation schedule.

Another cooking factor 316 may, for example, be a cooking surface on which the food item is to be placed within cooking chamber 14. The cooking surface may be selected form a plurality of cooking surface options, which may include for example a metal pan, a baking stone 70, a pizza screen, a cooking chamber 14 surface (i.e. the baking rack 24 or other surface provided in the cooking chamber 14), etc. In some embodiments wherein the cooking surface is a baking stone 70, an additional cooking factor 316 may be provided, which may be an internal baking stone temperature. Such temperature may for example be measured by one or more temperature sensors 72.

A method 300 in accordance with the present disclosure may further include, for example, the step 320 of configuring the oven appliance 10 for cooking based on each of the plurality of cooking factors 316 of the cooking profile 312 obtained in step 310. For example, controller 50 may operate the heating elements 42, 48 and fan 66 in accordance with the specified activation schedules and/or may operate the heating elements 42, 48 in a manner such that suitable temperatures in the cooking chamber 14 and internally in the baking stone 70 are maintained for suitable times. Controller 50 may additionally, for example, provide an indication of the cooking surface associated with the obtained cooking profile 312, such as on a display 92 which is in communication with controller 50. A user may, after seeing or hearing such indication, provide the desired cooking surface within the cooking chamber 14 for cooking of the food item.

In some embodiments, method 300 may further include the step 330 of inserting one or more food items into the cooking chamber 14. For example, a user may insert such food items into the cooking chamber 14. Further, in some embodiments, method 300 may further include the step 340 of cooking the food items in the oven appliance 10, such as in the cooking chamber 14 thereof, utilizing each of the plurality of cooking factors 316 as discussed above.

Use of cooking profiles 312 in accordance with the present disclosure advantageously allows a user to prepare restaurant quality food items in desired food items styles using, for example, home-based oven appliances 10. Systems and methods in accordance with the present disclosure advantageously facilitate such cooking by allowing for a desired cooking profile 312 to be obtained and an oven appliance 10 to be configured for cooking based on that desired cooking profile 312.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for preparing a food item, the method comprising:
obtaining a cooking profile for the food item from a plurality of cooking profiles stored on a remote server, each of the plurality of cooking profiles comprising a food item style and a plurality of cooking factors associated with the food item style; and
configuring an oven appliance for cooking based on each of the plurality of cooking factors of the obtained cooking profile.

2. The method of claim 1, wherein the food item is a pizza.

3. The method of claim 1, wherein the plurality of cooking factors comprises a cooking temperature within a cooking chamber of the oven appliance and a cooking time at the cooking temperature.

4. The method of claim 1, wherein the oven appliance comprises a lower heating assembly and an upper heating assembly.

5. The method of claim 4, wherein the plurality of cooking factors comprises an activation schedule for the lower heating assembly and an activation schedule for the upper heating assembly that is different from the activation schedule for the lower heating assembly.

6. The method of claim 4, wherein the lower heating assembly comprises a plurality of lower heater elements and the upper heating assembly comprises a plurality of upper heater elements.

7. The method of claim 6, wherein the plurality of cooking factors comprises an activation schedule for at least one zone of lower heater elements and at least one zone of upper heater elements.

8. The method of claim 7, wherein the activation schedule comprises at least one deactivation time and at least one activation time for the at least one zone of lower heater elements and the at least one zone of upper heater elements.

9. The method of claim 8, wherein the activation schedule further includes a power level for the at least one activation time for the at least one zone of lower heater elements and the at least one zone of upper heater elements.

10. The method of claim 6, wherein the plurality of lower heater elements are arranged in a transversely extending row and the plurality of upper heater elements are arranged in a transversely extending row.

11. The method of claim 4, wherein the oven appliance comprises a channel disposed below the lower heating assembly along a vertical direction, a plurality of apertures providing fluid communication between the channel and the cooking chamber, and a fan operable to direct air into the channel.

12. The method of claim 11, wherein the plurality of cooking factors comprises an activation schedule for the fan.

13. The method of claim 1, wherein the plurality of cooking factors comprises a cooking surface.

14. The method of claim 13, wherein the cooking surface is selected from a plurality of cooking surface options, the plurality of cooking surface options comprising at least one of a metal pan, a baking stone, a pizza screen, and a cooking chamber surface.

15. The method of claim 14, wherein the plurality of cooking surface options comprises the baking stone, and wherein the plurality of cooking factors further comprises an internal baking stone temperature.

16. The method of claim 1, wherein the obtaining step and the applying step are performed by a controller of the oven appliance.

17. The method of claim 1, further comprising:
inserting a food item into a cooking chamber of the oven appliance; and
cooking the food item in the oven appliance utilizing each of the plurality of cooking factors.

18. A system for preparing a food item, the system comprising:
a remote server, the remote server storing a plurality of cooking profiles, each of the plurality of cooking profiles comprising a food item style and a plurality of cooking factors associated with the food item style; and
an oven appliance, the oven appliance comprising:
a cabinet defining a cooking chamber, the cooking chamber configured for receipt of food items to be cooked and comprising a top wall and a bottom wall spaced from the top wall along a vertical direction;
a lower heating assembly, the lower heating assembly comprising a heating element disposed within the cooking chamber adjacent the bottom wall;
an upper heating assembly, the upper heating assembly comprising a heating element disposed within the cooking chamber adjacent the top wall;
a temperature sensor disposed within the cooking chamber; and
a controller in communication with the remote server and operable to obtain a cooking profile of the plurality of cooking profiles, the controller further operable to configure the oven appliance for cooking based on each of the plurality of cooking factors of the obtained cooking profile.

19. The system of claim 18, further comprising a user interface device in communication with the controller and the remote server.

20. The system of claim 18, wherein the food item is a pizza.
